(19) United States
(12) Patent Application Publication
(10) Pub. No.: US 2026/0019413 A1
(43) Pub. Date: Jan. 15, 2026

(54) NETWORK ACCESS CONTROL METHOD, APPARATUS AND DEVICE, AND STORAGE MEDIUM

(71) Applicant: BEIJING BYTEDANCE NETWORK TECHNOLOGY CO., LTD., Beijing (CN)

(72) Inventors: Zefang Han, Beijing (CN); Yuwei Zheng, Beijing (CN); Mingchuang Qin, Beijing (CN); Haoliang Lu, Beijing (CN)

(21) Appl. No.: 18/848,882

(22) PCT Filed: Mar. 8, 2023
(86) PCT No.: PCT/CN2023/080236

§ 371 Date: Apr. 16, 2025

(30) Foreign Application Priority Data
Apr. 6, 2022 (CN) 202210357939.8

(51) Int. Cl. H04L 9/40

(52) U.S. Cl. CPC H04L 63/0823; H04L 63/123

(57) ABSTRACT

Embodiments of the present disclosure relate to a network access control method, apparatus and device, and a storage medium. The network access control method includes: receiving a certificate verification request sent by a terminal, and returning a certificate verification response to the terminal, wherein the certificate verification response carries a preset server certificate, the certificate verification response is used for instructing the terminal to verify the preset server certificate based on a root certificate installed in the terminal, and identity verification information of the root certificate is partially or fully different from identity verification information of the preset server certificate; and receiving a verification result returned by the terminal for the preset server certificate, and in a case where the verification result indicates that certificate verification succeeds, determining that the terminal has a security risk and interrupting a network access communication link of the terminal. In the embodiments of the present disclosure, when the terminal successfully verifies the preset server certificate, the terminal may be prevented from accessing a network by interrupting the network access communication link with the terminal, thereby improving the security of the network.

### CROSS-REFERENCE TO RELATED APPLICATION(S)

This application claims priority to Chinese Application No. 202210357939.8, filed on Apr. 6, 2022, and entitled “Network Access Control Method, Apparatus and Device, and Storage Medium”, the disclosure of which is incorporated herein by reference in its entity.

### FIELD

Embodiments of the present disclosure relate to the technical field of computers, and in particular to a network access control method, apparatus and device, and a storage medium.

### BACKGROUND

In recent years, with the rapid development of a wireless technology, enterprises have widely utilized a Wi-Fi protected access enterprise (WPA-Enterprise) manner of accessing a terminal to a network. The WPA-Enterprise requires an authentication server to perform network access authentication on each terminal that requests to access the network, so as to determine whether to provide a network access permission for the terminal.

However, when the terminal has a security risk, for example, a security vulnerability or an error in a related configuration for the network, the security of the network may be threatened once the terminal is allowed to successfully access the network.

### SUMMARY

In order to solve the above technical problems or at least partially solve the above technical problems, embodiments of the present disclosure provide a network access control method, apparatus and device, and a storage medium.

A first aspect of the embodiments of the present disclosure provides a network access control method, including: receiving a certificate verification request sent by a terminal, and returning a certificate verification response to the terminal, wherein the certificate verification response carries a preset server certificate, the certificate verification response is used for instructing the terminal to verify the preset server certificate based on a root certificate installed in the terminal, and identity verification information of the root certificate is partially or fully different from identity verification information of the preset server certificate; and receiving a verification result returned by the terminal for the preset server certificate, and in a case where the verification result indicates that certificate verification succeeds, determining that the terminal has a security risk and interrupting a network access communication link of the terminal.

A second aspect of the embodiments of the present disclosure provides a network access control apparatus, including: a return module, configured to receive a certificate verification request sent by a terminal, and return a certificate verification response to the terminal, wherein the certificate verification response carries a preset server certificate, the certificate verification response is used for instructing the terminal to verify the preset server certificate based on a root certificate installed in the terminal, and identity verification information of the root certificate is partially or fully different identity verification information of the preset server certificate; and an interruption module, configured to receive a verification result returned by the terminal for the preset server certificate, and in a case where the verification result indicates that certificate verification succeeds, determine that the terminal has a security risk and interrupt a network access communication link of the terminal.

A third aspect of the embodiments of the present disclosure provides a computer-readable storage medium, wherein a computer program is stored in the storage medium, and the computer program may implement, when executed by a processor, the method in the first aspect as described above.

A fourth aspect of the embodiments of the present disclosure provides a network access control device, including a processor and a memory, wherein a computer program is stored in the memory, and when the computer program is executed by the processor, the processor executes the method in the first aspect as described above.

A fifth aspect of the embodiments of the present disclosure provides a computer program product, including a computer program/instruction, wherein the computer program/instruction implements, when executed by a processor, the method in the first aspect as described above.

Compared with the prior art, the technical solutions provided in the embodiments of the present disclosure have the following advantages:

In the embodiments of the present disclosure, the certificate verification request sent by the terminal is received, and the certificate verification response is returned to the terminal; the certificate verification response carries the preset server certificate, the certificate verification response is used for instructing the terminal to verify the preset server certificate based on the root certificate installed in the terminal, and the identity verification information of the root certificate is partially or fully different from the identity verification information of the preset server certificate; and the verification result returned by the terminal for the preset server certificate is received, and in a case where the verification result indicates that certificate verification succeeds, it is determined that the terminal has the security risk and the network access communication link of the terminal is interrupted. In this way, during the process of performing network access authentication on the terminal that applies for network access, in a case where the terminal successfully verifies the preset server certificate, it indicates that the terminal cannot verify the authenticity of a server certificate sent by an authentication server, and thus there is a security risk, at this time, the authentication server can prevent the terminal from accessing the network by interrupting the network access communication link of the terminal, thereby improving the security of the network.

### BRIEF DESCRIPTION OF THE DRAWINGS

The drawings herein are incorporated in and constitute a part of the present specification, illustrate embodiments conforming to the present disclosure, and serve to explain the principles of the present disclosure together with the specification.

To illustrate technical solutions in the embodiments of the present disclosure or in the prior art more clearly, a brief introduction on the drawings which are needed in the description of the embodiments or the prior art is given below. Apparently, other drawings may be obtained by those ordinary skilled in the art according to these drawings without any creative effort.

FIG. 1 is a flowchart of a network access control method provided in an embodiment of the present disclosure;

FIG. 2 is a schematic diagram of a process of a network access control method provided in an embodiment of the present disclosure;

FIG. 3 is a schematic flowchart of another network access control method provided in an embodiment of the present disclosure;

FIG. 4 is a schematic structural diagram of a network access control apparatus provided in an embodiment of the present disclosure; and

FIG. 5 is a schematic structural diagram of a network access control device in an embodiment of the present disclosure.

### DETAILED DESCRIPTION OF EMBODIMENTS

In order to understand the above objectives, features and advantages of the present disclosure more clearly, the solutions of the present disclosure will be further described below. It should be noted that, in the case of no conflict, embodiments of the present disclosure and features in the embodiments may be combined with each other.

In the following description, numerous specific details are set forth to fully understand the present disclosure, but the present disclosure may also be implemented in other manners other than those described herein; and obviously, the embodiments in the specification are only a part, but not all, of the embodiments of the present disclosure.

The applicant has found by researches that, in a case where a terminal accesses a network by connecting a WPA-Enterprise named “Foo Inc” under normal circumstances, when a criminal constructs a phishing Wi-Fi named “Foo Inc”, since only the name “Foo Inc” of the WPA-Enterprise is recorded in configuration information stored on the terminal, when the signal of the phishing Wi-Fi is stronger, the terminal attempts to connect the phishing Wi-Fi.

When the terminal requests to access the network, an authentication server on a network side uses an extensible authentication protocol (EAP) to perform network access authentication on the terminal, and provides a network access permission for the terminal only after the terminal passes the authentication. The EAP includes a plurality of network access authentication mechanisms, such as PEAP, EAP-TLS, EAP-TTLS, EAP-SIM, EAP-AKA, EAP-FAST, EAP-PWD, and the like. The network access authentication mechanisms such as the PEAP, EAP-TTLS, EAP-TLS require the authentication server to send a server certificate to the terminal, so that the authentication server and the terminal negotiate a key via the server certificate, thereby establishing a security transport layer (TLS) tunnel. During the process of establishing the TLS tunnel, the authentication server sends the server certificate to the terminal, and only when the terminal verifies the server certificate based on a root certificate installed in the terminal and a verification result indicates that certificate verification succeeds, the terminal performs credential exchange with the authentication server. Theoretically, it is impossible for the criminal to forge the server certificate of the WPA-Enterprise named “Foo Inc”. Therefore, the terminal does not establish a connection with the phishing Wi-Fi. However, in actual situations, when the terminal has a security risk, for example, the terminal cannot verify the certificate of the authentication server due to the existence of a security vulnerability, or the terminal is configured to not verify the certificate of the authentication server by default in a related configuration for the network, then the terminal may mistakenly trust the server certificate of the phishing Wi-Fi, thereby connecting the phishing Wi-Fi. After the terminal establishes the connection with the phishing Wi-Fi, the criminal may acquire the information of the terminal in various manners, for example, a user credential, a user hash, and the like. Finally, the criminal may invade, via the information acquired from the terminal, a network that the terminal connects under normal circumstances.

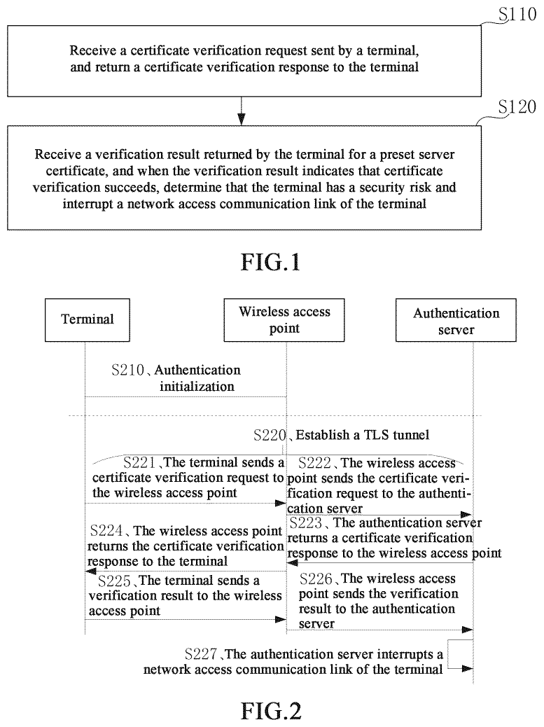

The applicant believes that the root cause of the terminal connecting the phishing Wi-Fi by mistake is that the terminal trusts the server certificate of the phishing Wi-Fi due to various causes. Based on this, the present disclosure provides a network access control method, apparatus and device, and a storage medium, wherein the network access control method may prevent a terminal, which has a security risk such as a security vulnerability or an error in a related configuration for a network, from accessing the network, thereby improving the security of the network. The network access control method will be described in detail below with reference to FIG. 1 to FIG. 3.

FIG. 1 is a flowchart of a network access control method provided in an embodiment of the present disclosure, and the method may be executed by a network access control device. The network access control device may include an authentication server, and the authentication server may be exemplarily understood as a device having storage and computing functions, such as a cloud server or a server cluster, or the like. As shown in FIG. 1, the method provided in the present embodiment includes the following steps:

S110, a certificate verification request sent by a terminal is received, and a certificate verification response is returned to the terminal.

In the embodiment of the present disclosure, during the process of performing network access authentication on the terminal which applies for network access, the authentication server may perform certificate verification on the terminal to verify whether the terminal is a terminal having a security risk. During the process of performing certificate verification on the terminal, upon receiving the certificate verification request sent by the terminal, the authentication server may return the certificate verification response to the terminal, so that the terminal verifies, based on a root certificate installed in the terminal, a preset server certificate carried in the certificate verification response.

Specifically, the certificate verification request may be any request that may enable the authentication server to return the certificate verification response to the terminal, which is not limited herein in terms of the specific form. For example, the certificate verification request may include an EAP-Response/TLS Client Hello message, but it is not limited thereto. The EAP-Response/TLS Client Hello message will be described in detail below, thus details are not repeated herein at first.

The certificate verification response carries the preset server certificate, and the certificate verification response is used for instructing the terminal to verify the preset server certificate based on the root certificate installed in the terminal.

Specifically, the certificate verification response may be any response carrying the preset server certificate, which is not limited herein in terms of the specific form. For example, the certificate verification request may include an Access-Challenge message, but it is not limited thereto. The Access-Challenge message will be described in detail below, thus details are not repeated herein at first.

Specifically, the root certificate is a certificate issued by a digital certificate authority (CA).

Specifically, identity verification information of the root certificate is partially or fully different from identity verification information of the preset server certificate.

The identity verification information may include at least one of a certificate name, a certificate validity time, a certificate issuance organization, key information, and the like. For the key information, the root certificate may include an encryption result, and the preset server certificate may include a certificate public key. However, it is not limited thereto.

Correspondingly, the terminal verifying the preset server certificate may include at least one of: determining whether the certificate name in the identity verification information of the root certificate is the same as the certificate name in the identity verification information of the preset server certificate; determining whether the certificate validity time in the identity verification information of the root certificate is the same as the certificate validity time in the identity verification information of the preset server certificate; determining whether the certificate issuance organization in the identity verification information of the root certificate is the same as the certificate issuance organization in the identity verification information of the preset server certificate; and determining whether an encryption result obtained by encrypting the certificate public key based on a preset public key encryption algorithm (e.g., an RSA algorithm) is the same as an encryption result in the root certificate. However, it is not limited thereto.

Specifically, the root certificate may be installed in the terminal in advance, so that upon receiving the certificate verification response, the terminal may verify the preset server certificate based on the root certificate.

It can be understood that, when the terminal is a terminal having no security risk such as the security vulnerability or the error in the related configuration for the network, that is, when the terminal can correctly verify the authenticity of the server certificate sent by the authentication server, since the identity verification information of the root certificate is partially or fully different from the identity verification information of the preset server certificate, the verification result of the terminal for the preset server certificate should be that certificate verification fails; and when the terminal has a security risk, the verification result of the terminal for the preset server certificate should be that the certificate verification succeeds.

S120, a verification result returned by the terminal for the preset server certificate is received, and in a case where the verification result indicates that certificate verification succeeds, it is determined that the terminal has a security risk and a network access communication link of the terminal is interrupted.

In the embodiment of the present disclosure, the authentication server may receive the verification result returned by the terminal for the preset server certificate. When the verification result indicates that the certificate verification succeeds, the authentication server may determine that the terminal has a security risk. At this time, the network access communication link of the terminal may be interrupted, thereby preventing the terminal from accessing the network, and improving the security of the network.

Specifically, the verification result may be any message that may enable the authentication server to learn about a verification success or failure of the terminal for the preset server certificate, and the specific form thereof is not limited herein. For example, the verification result may include a verification success message, and the verification success message may include an EAP-Rsponse/TLS Client Key Exchange message, but it is not limited thereto. The EAP-Rsponse/TLS Client Key Exchange message will be described in detail below, thus details are not repeated herein at first.

Specifically, in order to enable the authentication server to implement the network access control method provided in the embodiment of the present disclosure, the authentication server may be implemented based on freeradius. Since the freeradius utilizes a modular design and supports a plurality of EAP authentication mechanisms, an eap-recheck-tls module may be added based on the existing authentication server, and no matter a finally negotiated authentication mechanism of the authentication server and the terminal is any authentication mechanism of EAP-PEAP, EAP-Fast, EAP-TLS, EAP-T TLS protocol, and the like, the eap-recheck-tls module can be used for implementing the network access control method provided in the embodiment of the present disclosure. By using the modular development, the coupling between the eap-recheck-tls module and the existing authentication server is low, and the cohesiveness is high, thereby facilitating to reduce the difficulty in landing and deploying the solution, and improving the development efficiency.

It can be understood that, after the authentication server interrupts the network access communication link of the terminal, the terminal cannot pass the network access authentication of the authentication server, and then the terminal cannot access the network.

Exemplarily, FIG. 2 is a schematic diagram of a process of a network access control method provided in an embodiment of the present disclosure. Referring to FIG. 2, the network access control method includes the following steps: S210, authentication initialization. Specifically, the authentication initialization may include the following steps: 1) The terminal sends an EAPOL-Start message to a wireless access point to start 802.1x access. 2) The wireless access point sends an EAP-Request/Identity message to the terminal, so as to require the terminal to send user information. 3) The terminal responds an EAP-Response/Identity to the request of the wireless access point, including a network identifier of the user and a user ID. The user ID for a PEAP-mschchapv2 authentication mechanism is manually input or configured by the user on a client. It is suggested that a user name is the same as a portal authentication username password of the user. 4) The wireless access point sends the EAP-Response/Identity to an authentication server in the format of an EAP Over RADIUS message together with the attribute of the related authentication server. 5) The authentication server receives the EAP-Response/Identity sent by the wireless access point, determines, according to a configuration, to use the EAP-PEAP authentication mechanism, and sends an Access-Challenge message of the authentication server to the wireless access point, the Access-Challenge message includes an EAP-Request/Peap/Start message sent by the authentication server to the terminal, indicating that it is expected to start the authentication of the EAP-PEAP. 6) The wireless access point sends the EAP-Request/Peap/Start to the terminal.

S220, attempting to establish a TLS tunnel. S220 may specifically include the following steps: S221, the terminal sends a certificate verification request to the wireless access point. Specifically, S221 may include: 7) after receiving the EAP-Request/Peap/Start message, the terminal generates a random number, an encryption algorithm list supported by the client, a TLS protocol version, a session ID, and a compression method (all are NULL at present), and the terminal packages the above in an EAP-Response/TLS/Client Hello message and then sends the message to the wireless access point. S222, the wireless access point sends the certificate verification request to the authentication server. Specifically, S222 may include: 8) the wireless access point sends the EAP-Response/TLS/Client Hello to the authentication server in the format of the EAP over EAP Over RADIUS message together with the attribute of the related authentication server. S223, the authentication server returns a certificate verification response to the wireless access point. Specifically, S223 may include: 9) after receiving the Client Hello message, the authentication server selects a group of encryption algorithms that the authentication server supports from an encryption algorithm list of the Client Hello message, so as to form a Server Hello message by using the selected a group of encryption, a random number generated by a Server, a preset server certificate, a certificate request and a Server_Hello_Done attribute, and the authentication server packages the Server Hello message in an EAP message, and sends the EAP message to the wireless access point by using the Access-Challenge message (that is, the certificate verification response). S224, the wireless access point returns the certificate verification response to the terminal. Specifically, S224 may include: 10) the wireless access point sends an EAP-request message in an authentication server message to the terminal. S225, the terminal sends a verification result to the wireless access point. Specifically, S225 includes: 11) after receiving the message, the terminal verifies whether the preset server certificate is legitimate (using a root certificate acquired from a CA for verification, and mainly verifying whether a certificate validity time is legitimate and whether a certificate name is legitimate). In a case where the verification result of the terminal for the preset server certificate is that certificate verification succeeds (i.e, it is confirmed that the preset server certificate is legitimate), a certificate public key is extracted from the preset server certificate, a random password string pre-master-secret is generated at the same time, the random password string is encrypted by using the certificate public key in the preset server certificate, finally the encrypted information Client Key Exchange, the certificate of the terminal (if there is no certificate, the attribute may be set to 0), and a TLS finished attribute are packaged into an EAP-Rsponse/TLS Client Key Exchange message (that is, a certificate verification success message), and the EAP-Rsponse/TLS Client Key Exchange message is sent to the wireless access point. S226, the wireless access point sends the verification result to the authentication server. Specifically, S226 includes: 12) the wireless access point sends the EAP-Response/TLS Client Key Exchange to the authentication server in the format of the EAP Over RADIUS message together with the attribute of the related authentication server. S227, the authentication server interrupts a network access communication link of the terminal. Specifically, S227 includes: 13) after receiving the message, the authentication server may determine that the terminal has a security risk, and interrupts the network access communication link with the terminal.

In the network access control method provided in the embodiment of the present disclosure, the certificate verification request sent by the terminal may be received, and the certificate verification response is returned to the terminal; the certificate verification response carries the preset server certificate, the certificate verification response is used for instructing the terminal to verify the preset server certificate based on the root certificate installed in the terminal, and the identity verification information of the root certificate is partially or fully different from the identity verification information of the preset server certificate; and the verification result returned by the terminal for the preset server certificate is received, and in a case where the verification result indicates that certificate verification succeeds, it is determined that the terminal has the security risk and the network access communication link of the terminal is interrupted. In this way, during the process of performing network access authentication on the terminal that applies for network access, in a case where the terminal successfully verifies the preset server certificate, it indicates that the terminal cannot verify the authenticity of a server certificate sent by the authentication server, and thus there is a security risk, at this time, the authentication server may prevent the terminal from accessing the network by interrupting the network access communication link of the terminal, thereby improving the security of the network.

In another implementation of the present disclosure, the method further includes: S130, in response to determining that verification of the terminal for the preset server certificate fails, re-initiating a network access authentication process for the terminal.

Specifically, in a case where the verification result of the terminal for the preset server certificate is that the certificate verification fails, it indicates that the terminal is a secure terminal, and at this time, the authentication server may re-initiate the network access authentication process for the terminal.

Specifically, specific steps of the network access authentication process may be set by those skilled in the art according to actual conditions, which is not limited herein. In the re-initiated network access authentication process, the authentication server may send, to the terminal, the certificate issued by the CA, and identity verification information in the certificate is the same as the identity verification information of the root certificate installed in the terminal. For example, the certificate name, the certificate validity time and the certificate issuance organization in the identity verification information of the root certificate are the same as those in the identity verification information of the preset server certificate, and the encryption result obtained by encrypting the certificate public key based on the preset public key encryption algorithm (e.g., the RSA algorithm) is the same as the encryption result in the root certificate. However, it is not limited thereto.

Exemplarily, the re-initiated network access authentication procedure may include the following steps: first, authentication initialization, in which the specific steps of authentication initialization may refer to the above description with respect to FIG. 2, thus details are not described herein again; then, establishing a TLS tunnel, wherein the specific step of establishing the TLS tunnel differs from the above description with respect to FIG. 2 in that the Access-Challenge message includes the certificate issued by the CA instead of the preset server certificate, and the identity verification information of the certificate is the same as the identity verification information of the root certificate installed in the terminal; and then, performing authentication based on an authentication mechanism determined in the authentication initialization. When the terminal passes the network access authentication, the terminal may access the network.

It can be understood that, when the verification of the terminal for the preset server certificate fails, that is, when the terminal can verify the authenticity of the server certificate sent by the authentication server, the authentication server re-initiates the network access authentication process for the terminal, so that when the terminal passes the authentication in the re-initiated network access authentication process, the terminal can successfully access the network. In this way, the purpose of allowing a secure terminal to access the network and preventing a risk terminal from accessing the network can be achieved.

Optionally, S130 may specifically include: in a case where the verification result indicates that the certificate verification fails, or in response to determining that the verification result for the preset server certificate is not received from the terminal within a preset duration, re-initiating the network access authentication process for the terminal, wherein the preset duration is used for indicating a duration from a moment at which the certificate verification response is sent to the authentication server to a current moment.

Specifically, the verification result for the preset server certificate may include a verification failure message. The verification failure message may be any message that may enable the authentication server to learn that the verification result of the terminal for the preset server certificate is a verification failure, which is not limited herein in terms of the specific form.

Specifically, a specific value of the preset duration may be set by those skilled in the art according to actual conditions, which is not limited herein.

It can be understood that, in a case where the verification result indicates that the certificate verification fails, or in response to determining that the verification result for the preset server certificate is not received from the terminal within the preset duration, it is determined that the terminal is a secure terminal, thereby being simple to operate and easy to implement.

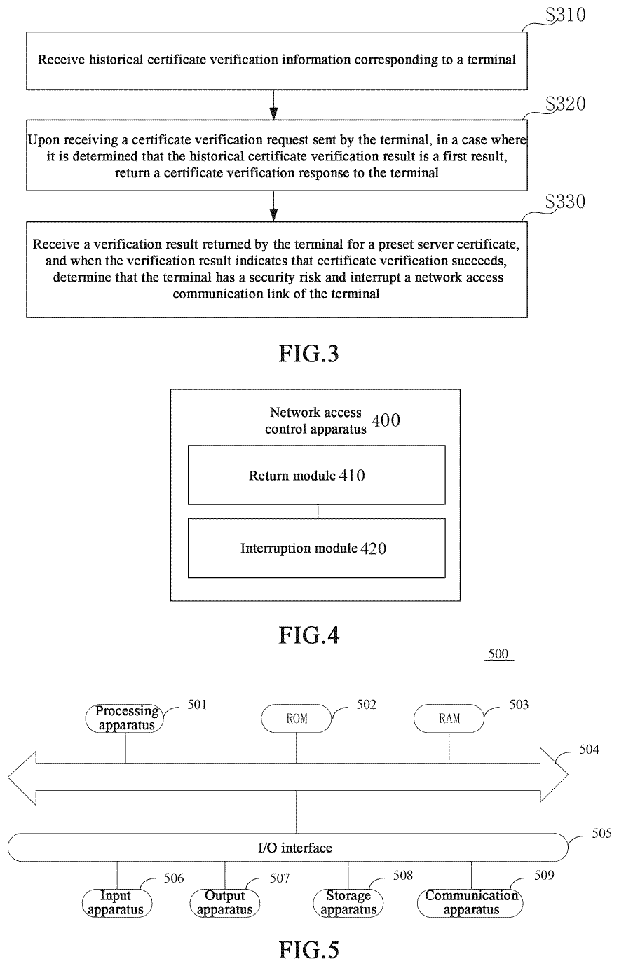

FIG. 3 is a schematic flowchart of another network access control method provided in an embodiment of the present disclosure. The embodiment of the present disclosure is optimized based on the above embodiment, and the embodiment of the present disclosure may be combined with each optional solution in one or more above embodiments.

As shown in FIG. 3, the network access control method may include the following steps:

S310, historical certificate verification information corresponding to a terminal is received.

In the embodiment of the present disclosure, before performing certificate verification on the terminal, an authentication server may acquire the historical certificate verification information corresponding to the terminal, so as to determine, based on the historical certificate verification information, whether it is necessary to perform certificate verification on the terminal.

The historical certificate verification information includes a historical certificate verification result, and the historical certificate verification result is used for identifying a latest verification result of the terminal for a preset server certificate.

Specifically, the verification result may be one of a first result, a second result and a third result. The first result is used for identifying that the latest verification result of the terminal for the preset server certificate is that the certificate verification succeeds, the second result is used for identifying that the latest verification result of the terminal for the preset server certificate is that the certificate verification fails, and the third result is used for identifying that the terminal does not perform verification for the preset server certificate.

Specifically, after performing certificate verification on the terminal to obtain certificate verification information (that is, the historical certificate verification information of the next certificate verification), the authentication server may store the certificate verification information in a local file or update the certificate verification information to a cloud server in a manner of covering the previous certificate verification information.

It should be noted that, a specific implementation of storing the certificate verification information in the local file may be set by those skilled in the art according to actual situations, which is not limited herein.

Exemplarily, the authentication server itself includes a plurality of protocol attributes, and in the embodiment of the present disclosure, based on the plurality of protocol attributes included in the authentication server itself, a protocol attribute is newly added to indicate the certificate verification result of the terminal for the preset server certificate, and the protocol attribute is specifically as follows:

### ATTRIBUTE TLS-Client-Verify-Cert 1901 Signed

“TLS-Client-Verify-Cert” denotes a name of the protocol attribute, “1901” denotes a field where the protocol attribute is located, “signed” may denote different detection results at different values. For example, when “signed” is equal to 1, it indicates that the detection result is the first result; when “signed” is equal to 0, it indicates that the detection result is the second result; and when “signed” is equal to −1, it indicates that the detection result is the third result.

The authentication server may perform certificate verification on the terminal to obtain certificate verification information, update a hash table based on the certificate verification information, and store the certificate verification information in the local file, or upload the certificate verification information to the cloud server. A specific implementation of storing the certificate verification information in the local file may be as follows: adding the above protocol attribute into a certain message returned by the authentication server to the terminal, and reading the message from a log, so that the certificate verification information is stored in the local file.

In some embodiments, S310 may specifically include: searching for, from a hash table and based on a terminal identifier of the terminal, historical certificate verification information corresponding to the terminal identifier. A correspondence between terminal identifiers and historical certificate verification information is stored in the hash table, and the hash table is obtained by pre-loading a local file stored with the historical certificate verification information.

Specifically, the terminal identifier may include a user ID, a mac address, and the like, but it is not limited thereto.

Specifically, when started, the authentication server may pre-load, into the hash table, the local file stored with the historical certificate verification information. Upon receiving a certificate verification request sent by the terminal, the authentication server may search for, from the hash table and based on the terminal identifier of the terminal, historical certificate verification information corresponding to the terminal identifier, and determine, based on the historical certificate verification information, whether it is necessary to perform certificate verification on the terminal.

It can be understood that the hash table is located in a memory that may be directly operated by the authentication server, and the hash table itself has the characteristic of high search efficiency. Therefore, compared with searching for the historical certificate verification information from the local file, the authentication server searches for the historical certificate verification information from the hash table at a higher speed, thereby facilitating to improve the search efficiency.

In some other embodiments, S310 may specifically include: sending a historical certificate verification information request to a cloud server, wherein the historical certificate verification information request carries a terminal identifier of the terminal; and receiving historical certificate verification information returned by the cloud server.

Specifically, upon receiving the certificate verification request sent by the terminal, the authentication server sends the historical certificate verification information request to the cloud server.

It can be understood that the historical certificate verification information is acquired by sending the historical certificate verification information request to the cloud server, so that there is no need to store the historical certificate verification information in the authentication server, thereby saving the memory of the authentication server.

S320, upon receiving a certificate verification request sent by the terminal, in a case where it is determined that the historical certificate verification result is a first result, a certificate verification response is returned to the terminal.

Optionally, in a case where it is determined that the historical certificate verification result is a third result, the certificate verification response is returned to the terminal.

Optionally, in a case where it is determined that the historical certificate verification result is a second result, there is no need to perform certificate verification on the terminal. The authentication server may return the certificate verification request to the terminal during the current network access authentication process, the certificate verification request carries a certificate issued by a CA, and identity verification information of the certificate is the same as the identity verification information of the root certificate installed in the terminal.

It can be understood that, in a case where the historical certificate verification result is the first result and the third result, it indicates that the probability of the terminal being a risk terminal is relatively large, at this time, it is necessary to perform certificate verification on the terminal to prevent the risk terminal from accessing the network to obtain information related to the accessed network, and leaking the information related to the accessed network. In a case where the historical certificate verification result is the second result, it indicates that the probability of the terminal being the risk terminal is relatively small, at this time, the process of performing certificate verification on the terminal may be omitted, so as to shorten the time of the terminal accessing the network and to improve the networking speed.

S330, a verification result returned by the terminal for a preset server certificate is received, and in a case where the verification result indicates that certificate verification succeeds, it is determined that the terminal has a security risk and a network access communication link of the terminal is interrupted.

Specifically, S330 is similar to S120, and thus details are not described herein again.

In the network access control method provided in the embodiment of the present disclosure, in a case where the historical certificate verification result is the first result and the third result, the certificate verification response is returned to the terminal, and in a case where the historical certificate verification result is the second result, the certificate verification request is returned to the terminal, so that the authentication server can perform certificate verification when the terminal has a relative high possibility of having a security risk, and perform no certificate verification when the terminal has a relative low possibility of having the security risk. In this way, the risk terminal can be prevented from accessing the network, thereby protecting the network, and improving the networking speed of the secure terminal.

In another implementation of the present disclosure, the historical certificate verification information further includes a certificate verification time corresponding to the historical certificate verification result. The method further includes: after acquiring the historical certificate verification information corresponding to the terminal, in a case where it is determined that the historical certificate verification result is a second result, determining whether a time difference between the certificate verification time corresponding to the historical certificate verification result and the current moment is greater than a preset time threshold value. The second result is used for identifying that the latest verification result of the terminal for the preset server certificate is that the certificate verification fails; and returning the certificate verification response to the terminal correspondingly includes: in a case where it is determined that the time difference between the certificate verification time corresponding to the historical certificate verification result and the current moment is greater than the preset time threshold value, returning the preset server certificate to the terminal.

Specifically, a specific value of the preset time threshold value may be set by those skilled in the art according to actual conditions, which is not limited herein.

Specifically, in a case where it is determined that the historical certificate verification result is the second result, and it is determined that the time difference between the certificate verification time corresponding to the historical certificate verification result and the current moment is greater than the preset time threshold value, the certificate verification response is returned to the terminal; and in a case where it is determined that the historical certificate verification result is the second result, and it is determined that the time difference between the certificate verification time corresponding to the historical certificate verification result and the current moment is less than or equal to the preset time threshold value, the certificate verification request is returned to the terminal.

It can be understood that, in a case where the historical certificate verification result is the second result and the time difference between the certificate verification time corresponding to the historical certificate verification result and the current moment is greater than the preset time threshold value, it indicates that the probability of the terminal having the security risk is relatively large. At this time, the certificate verification may be performed on the terminal to prevent the terminal having the security risk, for example, after the terminal accesses the network, obtaining information related to the accessed network, and leaking the information related to the accessed network. In a case where the historical certificate verification result is the second result and the time difference between the certificate verification time corresponding to the historical certificate verification result and the current moment is less than or equal to the preset time threshold value, it indicates that the probability of the terminal having the security risk is relatively small, at this time, the process of performing the certificate verification on the terminal may be omitted. In this way, the risk terminal can be further prevented from accessing the network, thereby protecting the network and improving the networking speed of the secure terminal.

Of course, upon receiving the certificate verification request sent by the terminal, in a case where it is determined that the historical certificate verification result is the third result, or in a case where it is determined that the time difference between the certificate verification time corresponding to the historical certificate verification result and the current moment is greater than the preset time threshold value, those skilled in the art may also return the certificate verification response to the terminal. Upon receiving the certificate verification request sent by the terminal, in a case where it is determined that the historical certificate verification result is the first result or the second result, and in a case where it is determined that the time difference between the certificate verification time corresponding to the historical certificate verification result and the current moment is less than or equal to the preset time threshold value, those skilled in the art may return the certificate verification request to the terminal, which is not limited in the present disclosure.

In yet another implementation of the present disclosure, the method further includes: before interrupting the network access communication link of the terminal, in a case where the verification result indicates that the certificate verification succeeds, sending an alarm message to the terminal.

Specifically, the alarm message may be any message that may enable the terminal to learn about that itself is as a risk terminal, and the specific form thereof is not limited herein.

In some embodiments, sending the alarm message to the terminal may include: based on a mobile phone number bound to the terminal, the authentication server may send the alarm message to the terminal.

In some other embodiments, sending the alarm message to the terminal may include: sending the alarm message to a third-party application client included in the terminal, so that the third-party application client displays the alarm message.

Specifically, the third-party application client may include an instant messaging client or a mail client or the like, which is not limited herein.

It can be understood that, by sending the alarm message to the terminal, a user of the terminal may perform self-inspection on the terminal in time according to the alarm message, so as to determine whether the terminal has a security risk, for example, a security vulnerability or an error in a related configuration for the network, thereby solving these problems as soon as possible, so that the terminal becomes a secure terminal, and thus can successfully access the network.

FIG. 4 is a schematic structural diagram of a network access control apparatus provided in an embodiment of the present disclosure, and the network access control apparatus 400 may be understood as the above network access control device or a part of functional modules in the above network access control device. As shown in FIG. 4, the network access control apparatus 400 includes: a return module 410 and an interruption module 420.

The return module 410 is configured to receive a certificate verification request sent by a terminal, and return a certificate verification response to the terminal, wherein the certificate verification response carries a preset server certificate, the certificate verification response is used for instructing the terminal to verify the preset server certificate based on a root certificate installed in the terminal, and identity verification information of the root certificate is partially or fully different from identity verification information of the preset server certificate.

The interruption module 420 is configured to receive a verification result returned by the terminal for the preset server certificate, and in a case where the verification result indicates that certificate verification succeeds, determine that the terminal has a security risk and interrupt a network access communication link of the terminal.

The network access control apparatus provided in the embodiment of the present disclosure may receive the certificate verification request sent by the terminal, and return the certificate verification response to the terminal, wherein the certificate verification response carries the preset server certificate, the certificate verification response is used for instructing the terminal to verify the preset server certificate based on the root certificate installed in the terminal, and the identity verification information of the root certificate is partially or fully different from the identity verification information of the preset server certificate; and the network access control apparatus may receive the verification result returned by the terminal for the preset server certificate, and in a case where the verification result indicates that certificate verification succeeds, determine that the terminal has the security risk and interrupt the network access communication link of the terminal. In this way, during the process of performing network access authentication on the terminal that applies for network access, in a case where the terminal successfully verifies the preset server certificate, it indicates that the terminal cannot verify the authenticity of a server certificate sent by an authentication server, and thus there is a security risk, at this time, the authentication server may prevent the terminal from accessing the network by interrupting the network access communication link of the terminal, thereby improving the security of the network.

In another implementation of the present disclosure, the apparatus further includes: a re-initiation module, configured to: in response to determining that verification of the terminal for the preset server certificate fails, re-initiate a network access authentication process for the terminal.

In still another implementation of the present disclosure, the re-initiation module may include: a re-initiation sub-module, configured to: in a case where the verification result indicates that the certificate verification fails, or in response to determining that a certificate verification result message for the preset server certificate is not received from the terminal within a preset duration, re-initiate the network access authentication process for the terminal, wherein the preset duration is used for indicating a duration from a moment at which the certificate verification response is sent to an authentication server to a current moment.

In still another implementation of the present disclosure, the apparatus may further include: an acquisition module, configured to: before returning the certificate verification response to the terminal, acquire historical certificate verification information corresponding to the terminal, wherein the historical certificate verification information comprises a historical certificate verification result, and the historical certificate verification result is used for identifying a latest verification result of the terminal for the preset server certificate; and correspondingly, a return module, configured to: in a case where it is determined that the historical certificate verification result is a first result, return the certificate verification response to the terminal, wherein the first result is used for identifying that the latest verification result of the terminal for the preset server certificate is that the certificate verification succeeds.

In still another implementation of the present disclosure, the historical certificate verification information further includes a certificate verification time corresponding to the historical certificate verification result.

The apparatus further includes: a determination module, configured to: after acquiring the historical certificate verification information corresponding to the terminal, in a case where it is determined that the historical certificate verification result is a second result, determine whether a time difference between the certificate verification time corresponding to the historical certificate verification result and the current moment is greater than a preset time threshold value, wherein the second result is used for identifying that the latest verification result of the terminal for the preset server certificate is that the certificate verification fails.

Correspondingly, the return module is configured to: in a case where it is determined that the time difference between the certificate verification time corresponding to the historical certificate verification result and the current moment is greater than the preset time threshold value, return the certificate verification response to the terminal.

In still another implementation of the present disclosure, the acquisition module may include: an acquisition sub-module, configured to search for, from a hash table and based on a terminal identifier of the terminal, historical certificate verification information corresponding to the terminal identifier, wherein a correspondence between terminal identifiers and historical certificate verification information is stored in the hash table, and the hash table is obtained by pre-loading a local file stored with the historical certificate verification information.

In still another implementation of the present disclosure, the apparatus further includes a sending module, configured to: before interrupting the network access communication link of the terminal, in a case where the verification result indicates that the certificate verification succeeds, send an alarm message to the terminal.

The apparatus provided in the present embodiment may execute the method according to any one of the foregoing embodiments, and execution manners and beneficial effects thereof are similar, thus details are not described herein again.

In addition to the above method and apparatus, an embodiment of the present disclosure further provides a computer-readable storage medium, wherein an instruction is stored in the computer-readable storage medium, and when the instruction is running on a terminal device, the terminal device is caused to implement the network access control method according to the embodiments of the present disclosure.

An embodiment of the present disclosure further provides a computer program product, including a computer program/instruction, wherein the computer program/instruction implements, when executed by a processor, the network access control method according to the embodiments of the present disclosure.

Exemplarily, FIG. 5 is a schematic structural diagram of a network access control device in an embodiment of the present disclosure. Hereinafter, referring to FIG. 5, it illustrates a schematic structural diagram of a network access control device 500 suitable for implementing the embodiments of the present disclosure. The network access control device 500 in the embodiment of the present disclosure may include, but is not limited to, mobile terminals such as mobile phones, notebook computers, digital broadcast receivers, PDAs (personal digital assistants), PADs (portable Android devices), PMPs (portable media players), vehicle-mounted terminals (e.g., vehicle-mounted navigation terminals), and the like, and fixed terminals such as digital TVs, desktop computers, and the like. The network access control device shown in FIG. 5 is merely an example, and should not bring any limitation to the functions and use ranges of the embodiments of the present disclosure.

As shown in FIG. 5, the network access control device 500 may include a processing apparatus (e.g., a central processing unit, a graphics processing unit, or the like) 501, which may execute various suitable actions and processes according to a program stored in a read-only memory (ROM) 502 or a program loaded from a storage apparatus 808 into a random access memory (RAM) 503. In the RAM 503, various programs and data needed by the operations of the network access control device 500 are also stored. The processing apparatus 501, the ROM 502 and the RAM 503 are connected with each other via a bus 504. An input/output (I/O) interface 505 is also connected to the bus 504.

In general, the following apparatuses may be connected to the I/O interface 505: an input apparatus 506, including, for example, a touch screen, a touch pad, a keyboard, a mouse, a camera, a microphone, an accelerometer, a gyroscope, and the like; an output apparatus 507, including, for example, a liquid crystal display (LCD), a speaker, a vibrator, and the like; a storage apparatus 508, including, for example, a magnetic tape, a hard disk, and the like; and a communication apparatus 509. The communication apparatus 509 may allow the network access control device 500 to communicate in a wireless or wired manner with other devices to exchange data. Although FIG. 5 illustrates the network access control device 500 having various apparatuses, it should be understood that not all illustrated apparatuses are required to be implemented or provided. More or fewer apparatuses may alternatively be implemented or provided.

In particular, according to the embodiments of the present disclosure, the processes described above with reference to the flowcharts may be implemented as computer software programs. For example, the embodiments of the present disclosure include a computer program product, which includes a computer program carried on a non-transitory computer-readable medium, and the computer program contains program codes for executing the method illustrated in the flowcharts. In such embodiments, the computer program may be downloaded and installed from a network via the communication apparatus 509, or installed from the storage apparatus 508, or installed from the ROM 502. When the computer program is executed by the processing apparatus 501, the above functions defined in the method of the embodiments of the present disclosure are executed.

It should be noted that, the computer-readable medium described above in the present disclosure may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (an EPROM or a flash memory), an optical fiber, a compact disc read-only memory (CD-ROM), an optical storage device, a magnetic storage device, or any suitable combination of the above. In the present disclosure, the computer-readable storage medium may be any tangible medium that contains or stores a program, wherein the program may be used by or in combination with an instruction execution system, apparatus or device. In the present disclosure, the computer-readable signal medium may include a data signal that is propagated in a baseband or used as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transport the program for use by or in combination with the instruction execution system, apparatus or device. Program codes contained on the computer-readable medium may be transmitted with any suitable medium, including, but not limited to: an electrical wire, an optical cable, RF (radio frequency), and the like, or any suitable combination thereof.

In some implementations, a client and a server may perform communication by using any currently known or future-developed network protocol, such as an HTTP (HyperText Transfer Protocol), and may be interconnected with any form or medium of digital data communication (e.g., a communication network). Examples of the communication network include a local area network (“LAN”), a wide area network (“WAN”), an international network (e.g., the Internet), and a peer-to-peer network (e.g., an ad hoc peer-to-peer network), as well as any currently known or future-developed network.

The computer-readable medium may be contained in the above network access control device; and it may also be present separately and is not assembled into the network access control device.

The computer-readable medium carries one or more programs that, when executed by the network access control device, cause the network access control device to: receive a certificate verification request sent by a terminal, and return a certificate verification response to the terminal, wherein the certificate verification response carries a preset server certificate, the certificate verification response is used for instructing the terminal to verify the preset server certificate based on a root certificate installed in the terminal, and identity verification information of the root certificate is partially or fully different from identity verification information of the preset server certificate; and receive a verification result returned by the terminal for the preset server certificate, and when the verification result indicates that certificate verification succeeds, determine that the terminal has a security risk and interrupt a network access communication link of the terminal.

Computer program codes for executing the operations of the present disclosure may be written in one or more programming languages or combinations thereof. The programming languages include object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer via any type of network, including a local area network (LAN) or a wide area network (WAN), or it may be connected to an external computer (e.g., via the Internet using an Internet service provider).

The flowcharts and block diagrams in the drawings illustrate the system architectures, functions and operations of possible implementations of systems, methods and computer program products according to various embodiments of the present disclosure. In this regard, each block in the flowcharts or block diagrams may represent a part of a module, a program segment or a code, and the part of the module, the program segment or the code contains one or more executable instructions for implementing specified logical functions. It should also be noted that, in some alternative implementations, the functions annotated in the blocks may occur out of the sequence annotated in the drawings. For example, two blocks shown in succession may, in fact, be executed substantially concurrently, or the blocks may sometimes be executed in a reverse sequence, depending upon the functions involved. It should also be noted that each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

The units involved in the described embodiments of the present disclosure may be implemented in a software or hardware manner. The names of the units do not constitute limitations of the units themselves in a certain case.

The functions described herein above may be executed, at least in part, by one or more hardware logic components. For example, without limitation, example types of the hardware logic components that may be used include: a field programmable gate array (FPGA), an application specific integrated circuit (ASIC), an application specific standard product (ASSP), a system on chip (SOC), a complex programmable logic device (CPLD), and so on.

In the context of the present disclosure, a machine-readable medium may be a tangible medium, which may contain or store a program for use by or in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium would include an electrical connection based on one or more wires, a portable computer disk, a hard disk, a random access memory (RAM), a read-only memory (ROM), an erasable programmable read-only memory (EPROM or a flash memory), an optical fiber, a compact disc read-only memory (CD-ROM), an optical storage device, a magnetic storage device, or any suitable combination thereof.

An embodiment of the present disclosure further provides a computer-readable storage medium, wherein a computer program is stored in the storage medium, and the computer program may implement, when executed by a processor, the method according to any one of the forgoing embodiments, and execution manners and beneficial effects thereof are similar, thus details are not described herein again.

It should also be noted that, relational terms herein, such as “first”, “second” and the like, are merely used for distinguishing one entity or operation from another entity or operation, and do not necessarily require or imply that any such actual relationship or order exists between these entities or operations. Moreover, the terms “include”, “contain” or any other variants thereof are intended to cover non-exclusive inclusions, such that a process, a method, an article or a device including a series of elements not only includes those elements, but also includes other elements that are not explicitly listed, or also includes elements inherent to such a process, method, article or device. If there are no more restrictions, the element defined by the sentence “including a . . . ” does not exclude the existence of other identical elements in the process, the method, the article or the device that includes the element.

The foregoing descriptions are merely specific implementations of the present disclosure, and are intended to enable those skilled in the art to understand or implement the present disclosure. Various modifications to these embodiments will be readily apparent to those skilled in the art, and the generic principles defined herein may be implemented in other embodiments without departing from the spirit or scope of the present disclosure. Thus, the present disclosure will not be limited to these embodiments described herein, but will conform to the widest scope consistent with the principles and novel features disclosed herein.

1. A network access control method, comprising:
receiving a certificate verification request sent by a terminal, and returning a certificate verification response to the terminal, wherein the certificate verification response carries a preset server certificate, the certificate verification response is used for instructing the terminal to verify the preset server certificate based on a root certificate installed in the terminal, and identity verification information of the root certificate is partially or fully different from identity verification information of the preset server certificate; and
receiving a verification result returned by the terminal for the preset server certificate, and in a case where the verification result indicates that certificate verification succeeds, determining that the terminal has a security risk and interrupting a network access communication link of the terminal.

2. The method according to claim 1, wherein the method further comprises:
in response to determining that verification of the terminal for the preset server certificate fails, re-initiating a network access authentication process for the terminal.

3. The method according to claim 2, wherein in response to determining that the verification of the terminal for the preset server certificate fails, re-initiating the network access authentication process for the terminal, comprises:
in a case where the verification result indicates that the certificate verification fails, or in response to determining that the verification result for the preset server certificate is not received from the terminal within a preset duration, re-initiating the network access authentication process for the terminal,
wherein the preset duration is used for indicating a duration from a moment at which the certificate verification response is sent to the authentication server to a current moment.

4. The method according to claim 1, further comprising: before returning the certificate verification response to the terminal,
acquiring historical certificate verification information corresponding to the terminal, wherein the historical certificate verification information comprises a historical certificate verification result, and the historical certificate verification result is used for identifying a latest verification result of the terminal for the preset server certificate; and
returning the certificate verification response to the terminal correspondingly comprises:
in a case where it is determined that the historical certificate verification result is a first result, returning the certificate verification response to the terminal, wherein the first result is used for identifying that the latest verification result of the terminal for the preset server certificate is that the certificate verification succeeds.

5. The method according to claim 4, wherein the historical certificate verification information further comprises a certificate verification time corresponding to the historical certificate verification result;
the method further comprises: after acquiring the historical certificate verification information corresponding to the terminal,
in a case where it is determined that the historical certificate verification result is a second result, determining whether a time difference between the certificate verification time corresponding to the historical certificate verification result and the current moment is greater than a preset time threshold value, wherein the second result is used for identifying that the latest verification result of the terminal for the preset server certificate is that the certificate verification fails; and
returning the certificate verification response to the terminal correspondingly comprises:
in response to determining that the time difference between the certificate verification time corresponding to the historical certificate verification result and the current moment is greater than the preset time threshold value, returning the certificate verification response to the terminal.

6. The method according to claim 4, wherein acquiring the historical certificate verification information corresponding to the terminal comprises:
searching for, from a hash table and based on a terminal identifier of the terminal, historical certificate verification information corresponding to the terminal identifier, wherein a correspondence between terminal identifiers and historical certificate verification information is stored in the hash table, and the hash table is obtained by pre-loading a local file stored with the historical certificate verification information.

7. The method according to claim 1, further comprising: before interrupting the network access communication link of the terminal,
in a case where the verification result indicates that the certificate verification succeeds, sending an alarm message to the terminal.

8. (canceled)

9. A non-transitory computer-readable storage medium, wherein an instruction is stored in the computer-readable storage medium, and when the instruction is running on a terminal device, the terminal device is caused to:
receive a certificate verification request sent by a terminal, and return a certificate verification response to the terminal, wherein the certificate verification response carries a preset server certificate, the certificate verification response is used for instructing the terminal to verify the preset server certificate based on a root certificate installed in the terminal, and identity verification information of the root certificate is partially or fully different from identity verification information of the preset server certificate; and
receive a verification result returned by the terminal for the preset server certificate, and in a case where the verification result indicates that certificate verification succeeds, determine that the terminal has a security risk and interrupting a network access communication link of the terminal.

10. A network access control device, comprising: a memory, a processor, and a computer program stored on the memory and executable on the processor, wherein the processor implements, when executing the computer program:
receiving a certificate verification request sent by a terminal, and returning a certificate verification response to the terminal, wherein the certificate verification response carries a preset server certificate, the certificate verification response is used for instructing the terminal to verify the preset server certificate based on a root certificate installed in the terminal, and identity verification information of the root certificate is partially or fully different from identity verification information of the preset server certificate; and
receiving a verification result returned by the terminal for the preset server certificate, and in a case where the verification result indicates that certificate verification succeeds, determining that the terminal has a security risk and interrupting a network access communication link of the terminal.

11. (canceled)

12. The non-transitory computer-readable storage medium according to claim 9, wherein the terminal device is further caused to:
in response to determining that verification of the terminal for the preset server certificate fails, re-initiate a network access authentication process for the terminal.

13. The non-transitory computer-readable storage medium according to claim 12, wherein the terminal device is caused to: in response to determining that the verification of the terminal for the preset server certificate fails, re-initiating the network access authentication process for the terminal by being caused to:
in a case where the verification result indicates that the certificate verification fails, or in response to determining that the verification result for the preset server certificate is not received from the terminal within a preset duration, re-initiate the network access authentication process for the terminal,
wherein the preset duration is used for indicating a duration from a moment at which the certificate verification response is sent to the authentication server to a current moment.

14. The non-transitory computer-readable storage medium according to claim 9, wherein the terminal device is further caused to: before returning the certificate verification response to the terminal,
acquire historical certificate verification information corresponding to the terminal, wherein the historical certificate verification information comprises a historical certificate verification result, and the historical certificate verification result is used for identifying a latest verification result of the terminal for the preset server certificate; and
wherein the terminal device is caused to return the certificate verification response to the terminal correspondingly by being caused to:
in a case where it is determined that the historical certificate verification result is a first result, return the certificate verification response to the terminal, wherein the first result is used for identifying that the latest verification result of the terminal for the preset server certificate is that the certificate verification succeeds.

15. The non-transitory computer-readable storage medium according to claim 14, wherein the historical certificate verification information further comprises a certificate verification time corresponding to the historical certificate verification result;
wherein the terminal device is further caused to: after the historical certificate verification information corresponding to the terminal is acquired,
in a case where it is determined that the historical certificate verification result is a second result, determine whether a time difference between the certificate verification time corresponding to the historical certificate verification result and the current moment is greater than a preset time threshold value, wherein the second result is used for identifying that the latest verification result of the terminal for the preset server certificate is that the certificate verification fails; and
wherein the terminal device is caused to return the certificate verification response to the terminal correspondingly by being caused to:
in response to determining that the time difference between the certificate verification time corresponding to the historical certificate verification result and the current moment is greater than the preset time threshold value, return the certificate verification response to the terminal.

16. The non-transitory computer-readable storage medium according to claim 14, wherein the terminal device is further caused to acquire the historical certificate verification information corresponding to the terminal by being caused to:
search for, from a hash table and based on a terminal identifier of the terminal, historical certificate verification information corresponding to the terminal identifier, wherein a correspondence between terminal identifiers and historical certificate verification information is stored in the hash table, and the hash table is obtained by pre-loading a local file stored with the historical certificate verification information.

17. The non-transitory computer-readable storage medium according to claim 9, wherein the terminal device is further caused to: before the network access communication link of the terminal is interrupted,
in a case where the verification result indicates that the certificate verification succeeds, send an alarm message to the terminal.

18. The network access control device according to claim 10, wherein the processor implements:
in response to determining that verification of the terminal for the preset server certificate fails, re-initiating a network access authentication process for the terminal.

19. The network access control device according to claim 18, wherein in response to determining that the verification of the terminal for the preset server certificate fails, re-initiating the network access authentication process for the terminal, comprises:
in a case where the verification result indicates that the certificate verification fails, or in response to determining that the verification result for the preset server certificate is not received from the terminal within a preset duration, re-initiating the network access authentication process for the terminal,
wherein the preset duration is used for indicating a duration from a moment at which the certificate verification response is sent to the authentication server to a current moment.

20. The network access control device according to claim 10, wherein the processor implements: before returning the certificate verification response to the terminal,
acquiring historical certificate verification information corresponding to the terminal, wherein the historical certificate verification information comprises a historical certificate verification result, and the historical certificate verification result is used for identifying a latest verification result of the terminal for the preset server certificate; and
returning the certificate verification response to the terminal correspondingly comprises:
in a case where it is determined that the historical certificate verification result is a first result, returning the certificate verification response to the terminal, wherein the first result is used for identifying that the latest verification result of the terminal for the preset server certificate is that the certificate verification succeeds.

21. The network access control device according to claim 20, wherein the historical certificate verification information further comprises a certificate verification time corresponding to the historical certificate verification result;
wherein the processor further implements: after acquiring the historical certificate verification information corresponding to the terminal,
in a case where it is determined that the historical certificate verification result is a second result, determining whether a time difference between the certificate verification time corresponding to the historical certificate verification result and the current moment is greater than a preset time threshold value, wherein the second result is used for identifying that the latest verification result of the terminal for the preset server certificate is that the certificate verification fails; and
returning the certificate verification response to the terminal correspondingly comprises:
in response to determining that the time difference between the certificate verification time corresponding to the historical certificate verification result and the current moment is greater than the preset time threshold value, returning the certificate verification response to the terminal.

22. The network access control device according to claim 20, wherein acquiring the historical certificate verification information corresponding to the terminal comprises:
searching for, from a hash table and based on a terminal identifier of the terminal, historical certificate verification information corresponding to the terminal identifier, wherein a correspondence between terminal identifiers and historical certificate verification information is stored in the hash table, and the hash table is obtained by pre-loading a local file stored with the historical certificate verification information.
